(19) United States
(12) Patent Application Publication
(10) Pub. No.: US 2007/0287389 A1
(43) Pub. Date: Dec. 13, 2007

(54) Wireless communication device

(76) Inventors: Scott Pockat, Rogers, AR (US); Michael Musteen, Chula Vista, CA (US); Barry Musteen, Centerton, AR (US)

Correspondence Address: KEISLING PIEPER & SCOTT PLC;Bank of America Plaza, Suite 217, 1 East Center Street, Fayetteville, AR, 72701, US

(21) Appl. No.: 11/811,962

(22) Filed: Jun. 12, 2007

Related U.S. Application Data
(60) Provisional application No. 60/812,823, filed on Jun. 12, 2006.

(51) Int. Cl. H04B 1/38; H04M 1/00

(52) U.S. Cl. 455/73; 455/575.1

(57) ABSTRACT

A device utilizing an alternative power source to provide wireless internet and wireless network access.

### CROSS-REFERENCE TO RELATED APPLICATIONS

This application claims priority to and is a continuation-in-part of U.S. application Ser. No. 60/812,823, filed Jun. 12, 2006.

### STATEMENT REGARDING FEDERALLY SPONSORED RESEARCH OR DEVELOPMENT

Not Applicable.

### REFERENCE TO A MICROFICHE APPENDIX

Not Applicable.

### RESERVATION OF RIGHTS

A portion of the disclosure of this patent document contains material which is subject to intellectual property rights such as but not limited to copyright, trademark, and/or trade dress protection. The owner has no objection to the facsimile reproduction by anyone of the patent document or the patent disclosure as it appears in the Patent and Trademark Office patent files or records but otherwise reserves all rights whatsoever.

### BACKGROUND OF THE INVENTION

1. Field of the Invention

The present invention relates to the field of electrical devices. In particular, the present invention relates specifically to a wireless access device utilizing an alternative energy source.

2. Description of the Known Art

As will be appreciated by those skilled in the art, alternative energy sources are utilized in a wide variety of products. Patents disclosing information relevant to alternative energy devices include U.S. Pat. No. 4,200,904, issued to Doan on Apr. 29, 1980; U.S. Pat. No. 4,265,422, issued to Van Leeuwen on May 5, 1981; U.S. Pat. No. 5,055,984, issued to Hung et al. on Oct. 8, 1991; U.S. Pat. No. 5,706,798, issued to Steinorth on Jan. 13, 1998; U.S. Pat. No. 6,201,181, issued to Azzam et al. on Mar. 13, 2001; U.S. Pat. No. 6,313,438, issued to Emerick on Nov. 6, 2001; U.S. Pat. No. 6,487,426, issued to Haber on Nov. 26, 2002; and U.S. Pat. No. 7,027,808, issued to Wesby on Apr. 11, 2006. Each of these patents are hereby expressly incorporated by reference in their entirety.

U.S. Pat. No. 4,200,904, issued to Doan on Apr. 29, 1980 entitled Solar powered street lighting system. The abstract provides the following information. The invention describes a solar powered street lighting system that is totally independent of any external power supply. Solar panels are connected in such a manner to charge a maintenance-free storage battery with sufficient capacity to light street lights and/or traffic signals. An auxiliary generator may also be provided having a wind driven vane for also charging the battery if sufficient sun light is not available.

U.S. Pat. No. 4,265,422, issued to Van Leeuwen on May 5, 1981 entitled Pole mounting solar panel device. The abstract provides the following information. The invention describes a single pole mounting solar panel device comprising at least one solar panel and upper and lower brackets fixed to the panel and to the pole, the upper bracket having a first flange means for mating with the pole and a first base plate fixed to the panel, the lower bracket means having a second flange means fixed to and encompassing a substantial portion of the circumference of the pole and a plane surface which extends out to the panel, the width of the plane surface varying from about the width of the pole to the width of the panel, the flange means for the lower bracket having upstanding side means extending longitudinally of the plane surface for about the full length of the plane surface, the side means and plane surface terminating at a second base plate fixed to the panel.

U.S. Pat. No. 5,055,984, issued to Hung et al. on Oct. 8, 1991 entitled Solar rechargeable light. The abstract provides the following information. The invention describes a solar rechargeable light has a lamp for illuminating a selected area such as the ground or a wall. A base is adapted to support the lamp in a fixed position to illuminate the selected area. An electrical storage device and power supply is electrically coupled to the lamp. A solar panel is electrically coupled to the electrical storage device for charging the storage device when the solar panel is exposed to light, wherein current from the storage device energizes the lamp, and wherein the solar panel is moveable relative to the base so that the orientation of the solar panel is substantially independent of an orientation of the lamp relative to the selected area.

U.S. Pat. No. 5,706,798, issued to Steinorth on Jan. 13, 1998 entitled Solar lens, stove and solar panel combination. The abstract provides the following information. The invention describes a solar assembly for heating a stove with solar energy. The assembly includes a foundation pipe having an opening. A substantially vertical pipe is positioned in the opening and the vertical pipe is capable of rotation relative to the foundation pipe. A stove is releasably attached to the vertical pole. A downward sloping arm is fixed to the top end of the vertical pole. A vertical adjustment member is slidably positionable on the downward sloping arm. The vertical adjustment member is capable of adjustment in height. A frame supporting a solar lens is pivotally attached to the vertical adjustment member. The vertical adjustment member is used to adjust the frame, and the solar lens, so that the solar lens directs solar energy to the stove. It is also contemplated that a solar panel or solar collector be positioned in place of the solar lens.

U.S. Pat. No. 6,201,181, issued to Azzam et al. on Mar. 13, 2001 entitled Portable solar module cart. The abstract provides the following information. The invention describes a portable solar module cart is provided which comprises a platform, a pair of wheels attached to opposite sides of the platform, a pair of support struts attached to opposite sides of the platform and movable relative to the platform between a first retracted position in which they lie substantially parallel to the platform and a second erected position in which they extend at a selected angle to the platform so that a DC power source can be disposed on and supported by the platform, a solar panel pivotally mounted to the struts, the solar panel being movable on its pivot when the struts are in their erected position so as to be in a perpendicular relationship with an imaginary line connecting the sun and the solar panel, whereby to maximize the solar energy collected by the panel, and means for locking the solar panel in any selected position on its pivot.

U.S. Pat. No. 6,313,438, issued to Emerick on Nov. 6, 2001 entitled Solar heated sleeping bag. The abstract provides the following information. The invention describes a solar heated sleeping apparatus has a sleeping bag having a rectangular lower portion and a rectangular upper portion wherein the lower and upper portions are partially connected on corresponding edges and partially fastened by a zipper along the remaining edges thereof. The sleeping apparatus includes a plurality of heating elements disposed within an inner liner of the upper portion. The apparatus further includes a solar cell mounted to a flexible panel and being removably coupled to the sleeping bag. The flexible panel with the solar cell may be removed from the sleeping bag and positioned at a selected angle upon adjustable support legs for receiving solar rays thereon. Solar energy received by the solar cell is connected to an inverter for recharging a battery. A control unit coupled to the battery and to the heating coils allows selected heating coils to be energized for heating the sleeping bag. The rechargeable battery may also be selectively connected to a vehicle power source or to a conventional AC power source for charging.

U.S. Pat. No. 6,487,426, issued to Haber on Nov. 26, 2002 entitled Self-aligning wireless interface system and method. The abstract provides the following information. The invention describes a self-aligning wireless interface system couples a wide variety of equipment to one or more of a wide variety of communications, entertainment, Internet, security, control, and/or other wireless services. The system can also provide a wireless interconnection among such equipment. The system can include an antenna system, geo-location module, communications module, orientation module, solar cell array, and rechargeable battery. The system provides a wireless link to satellite, airborne, and/or terrestrial transceivers, and optionally a wireless link connecting user equipment. To facilitate installation, the system can be deployed by a person possessing minimal or no technical qualifications, and it can power itself up into a fully operational state. The system optionally comprises a self-contained power system, which can include a solar cell array.

U.S. Pat. No. 7,027,808, issued to Wesby on Apr. 11, 2006 entitled System and method for monitoring and control of wireless modules linked to assets. The abstract provides the following information. A system and method for remote asset management is described which can provide the basis for a diverse product group including an improved remote location monitoring system, a means for communicating with and for monitoring the status and or location of a plurality of diverse assets, as well as the means for communicating with said assets for the purpose of modifying the operational status of one or more of said assets according to one or more stored data parameters such as location, use, battery power, and such like. The remote asset management system comprises a wireless module, which is associated with at least one of the plurality of asset and which is interfaced with the operating system of said assert and or with an electromechanical control means, which may control one or more features of the operation of said assets. A supporting network-based, or internet-based service platform, controls and manages the status of each of the plurality of assets, either automatically, or in response to received messages from fixed or wireless communication devices, and which is capable of selectively communicating data to said assets for changing the operational status of said assets according to pre-programmed conditions.

As known in the art, solar panels are utilized to provide energy to a number of devices. The majority of these devices utilize solar energy to power lights, heaters, and other necessary devices. As society relies more heavily upon internet and network devices, it becomes a necessity to provide an alternative energy device which provides an internet or network connection to a broad area for use by receivers within a specified area. Further, there is a need in the art to provide a solar panel assembly which provides an alternative energy source efficiently to a network access device. Additionally, there is a need in the art to provide a wireless assembly which can be easily installed within an area to provide wireless services. Thus, it may be seen that these prior art patents are very limited in their teaching and utilization, and an improved business directory system is needed to overcome these limitations.

### SUMMARY OF THE INVENTION

The present invention is directed to wireless network assembly. In accordance with one exemplary embodiment of the present invention, a wireless network assembly with a solar panel assembly is provided.

As discussed above, wireless access to internet, network servers, and other information systems is becoming more attractive for individuals, businesses, and other groups. Therefore, a need exists to provide an easily installed access device which can provide wireless access along while utilizing surroundings commonly found in every locale. The subject invention utilizes natural solar and wind energy to provide wireless communication from a self-contained assembly. Further, the assembly may be easily installed within an environment by securing loading brackets to a circular structure, such as a utility pole, light pole, or tree. In this manner, the assembly is removed from disruption in the area while providing a higher vantage point for transmission. It is the intent of the present invention to provide a compact, easily installed assembly which provides wireless communication access.

The present invention provides a compact assembly which may be easily installed. Solar panels are typically aligned in an angular configuration which is determined by the latitude of the location. Measuring the angle correctly is difficult, time-consuming, and current bracket assemblies for placement often make this positioning difficult. Therefore, it is an object of the present invention to provide a bracket for the solar panel which will allow a workman to accurately install a solar panel.

Additionally, it is an object of the present invention to provide a hinge which allows for easy placement of the solar panel. Solar panels typically are large, thus requiring multiple people to position the panel accurately. The present invention provides a hinge for securing the solar panel into place without the additional manpower.

It is an object of the present invention to provide a mount for a solar panel assembly which can be readily adjusted for a multitude of locations having differing latitudes.

It is an object of the present invention to provide a wireless access assembly which utilizes an alternative energy source.

It is an object of the present invention to provide a wireless access assembly which is adapted to be easily installed.

It is a further object of the present invention to provide a convenient housing for a wireless access assembly.

It is a further object of the present invention to provide a housing for the wireless assembly which will withstand the elements.

It is envisioned that the subject invention may be utilized by other communication arenas separate from wireless network access. Therefore, it is an object of the present invention to provide a wireless communication system for the provision of wireless network, internet, telephone services, and other digitally transmitted data.

Further, it is an object of the present invention to provide wireless communication to areas blighted by poverty, disaster, or other tragic events. The wireless communication device is adapted for easy installation in blighted areas to allow for communication access for government official, relief workers, or businesses. In this manner, a disaster area may provide quick access to communication information within hours despite downed power lines and communication towers.

These and other objects and advantages of the present invention, along with features of novelty appurtenant thereto, will appear or become apparent by reviewing the following detailed description of the invention.

### BRIEF DESCRIPTION OF THE SEVERAL VIEWS OF THE DRAWINGS

In the following drawings, which form a part of the specification and which are to be construed in conjunction therewith, and in which like reference numerals have been employed throughout wherever possible to indicate like parts in the various views:

FIG. 1 is a perspective view of the housing assembly and solar panel assembly of the present invention;

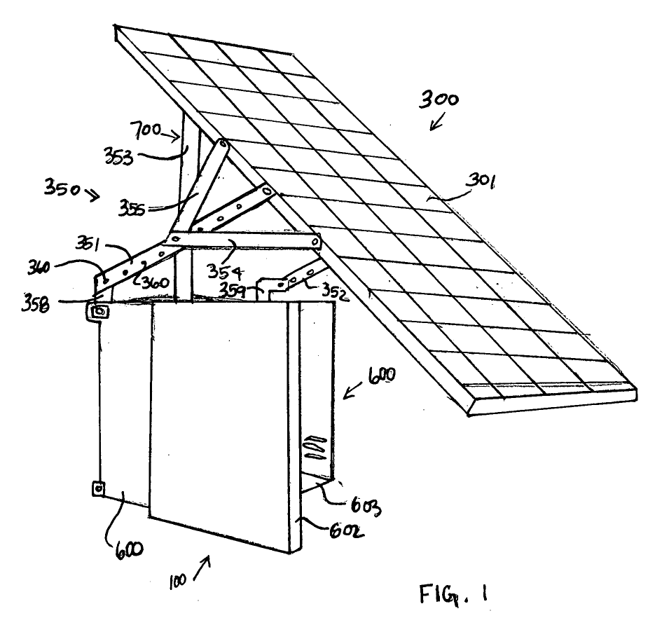

FIG. 2 is a perspective view of the present invention as installed;

FIG. 3 is a perspective view of the solar panel assembly of the present invention;

FIG. 4 is left side view of the same;

FIG. 5 is an enlarged view of the solar assembly attachment arm;

FIG. 6 is a perspective view of the housing assembly of the present invention showing lines 7-7 and 8-8;

FIG. 7 is a cross-sectional view of the housing assembly along line 7-7;

FIG. 8 is a cross-sectional view of the housing assembly along line 8-8;

FIG. 9 is a left side elevational view of the housing assembly as installed; and

FIG. 10 is a front plan view of the interior of the housing assembly.

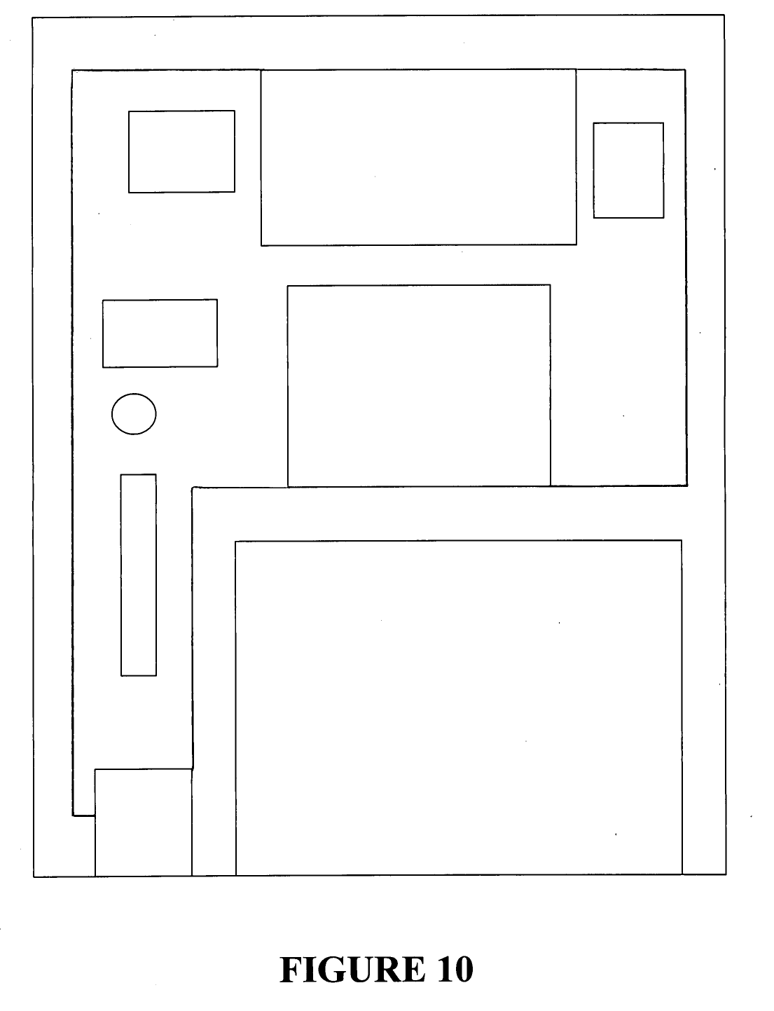

### DETAILED DESCRIPTION OF THE INVENTION

A wireless communication assembly is described herein and below. The present invention utilizes alternative energy sources to transfer information to communication devices such as laptops, network devices, or other portable electronic communication devices, from a wireless communication device.

As shown in the drawings, the present invention is directed to a self-contained wireless communication device 100 utilizing an alternative energy source. Further, the present invention is unique in its mounting and housing features as will be disclosed further below. In general, the invention includes an energy source 300, a server 400, an access point 500, a unitary housing 600, and a mount 700. The invention may further include additional energy devices 800, 900. The invention 100 as described is intended for mounting upon a cylindrical object 10, such as a tree or a pole. The assembly 100 may further be mounted to a polyhedron.

The energy source 300 includes a solar controller 320 (Morning Star, Washington Crossing, Pa.), to assist with providing a continuous stream of energy to the device 100, at least one solar panel 301 (Northern Arizona Wind and Star, Inc., Flagstaff Ariz.), and a solar panel mount 350. The solar panel mount 350 is described in detail below. The solar panel 301 supplies power to the solar controller 320. The solar controller 320 supplies 12 volts DC to the device 100 via a battery 310. The components in the device receive energy from the battery while the solar controller provides energy to the battery. All components used in the device 100 utilize 12 volts DC to operate.

The battery 310 remains charged by the solar controller for storage. In this manner, if the energy source 300 fails to provide energy for an extended period of time, such as at night, the electrical battery 310 can maintain energy flow to the wireless communication device 100 prior to maintenance of the device. In a preferred embodiment, the battery 310 includes a sensor linked to the server 400 so that a remote user can verify the amount of energy supply provided by the battery 310.

The solar panel mount 350 features at least two connecting braces 351, 352, a supporting brace 353 integral to the mount 700, a top brace 362 integral to the mount 700, and at least four angled braces 354, 355, 356, 357. In another embodiment, the solar panel mount 350 features a top brace 382, a bottom brace 383, a supporting brace 393, two attachment arms 384, 385, and connecting arms 386, 387, 388, 389. The connecting arms 386, 387, 388, 389 are attached to the solar panel and form a V-connection off of the solar panel frame. The solar panel includes a brace 375 for attachment to the solar panel mount 350. The top brace 382 and bottom brace 383 have rectangular protrusions 391, 392 on either side of the supporting brace 393 to space the mount away from the object 10 the mount is place upon. The bottom brace 383 has two extending arms 395, 396 which connect to the attachment arms 384, 385

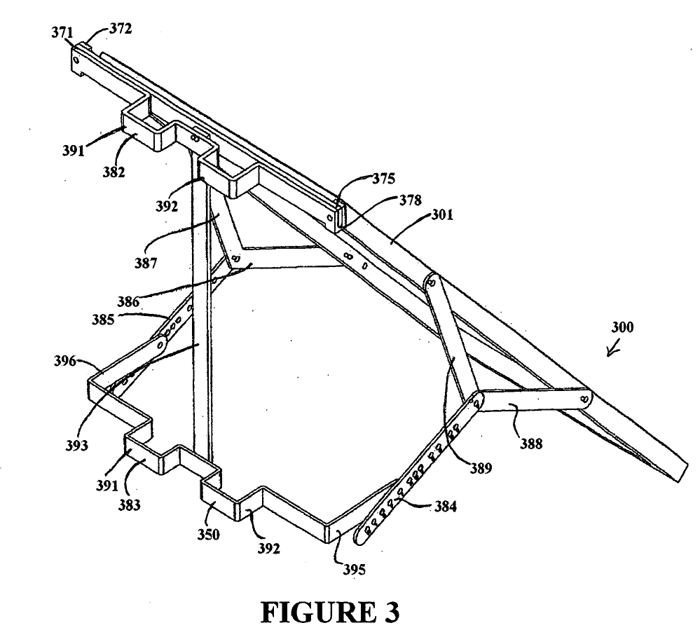

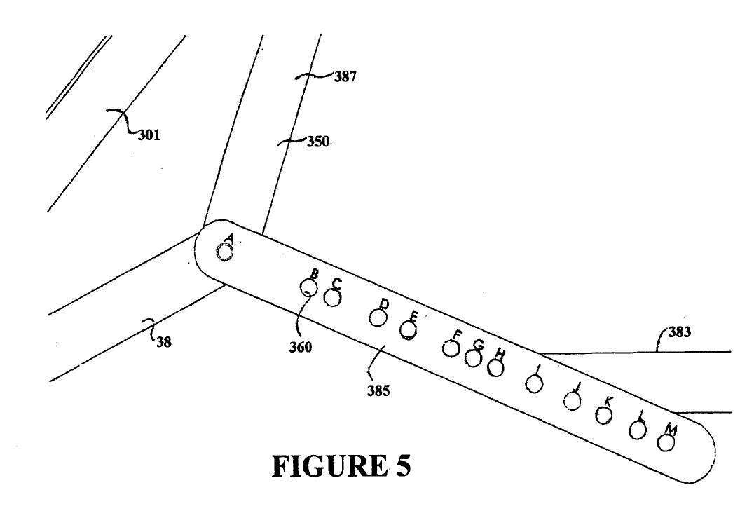

As shown in FIGS. 3-5, the attachment arms 384, 385 feature a multitude of docking positions 360 along the length of the attachment arms 384, 385. The multiple docking positions 360 allow the connecting arms 386, 387, 388, 389 to angle the solar panel 301 in at a variety of angles in relation to the supporting braces. As shown in FIG. 3, the bottom brace 383 of the mount connects to a specific docking position 360 to determine the angle of the solar panel 301.

Each docking position 360 allows for a two-degree angle variation for the solar panel 301. In this manner, mounting of the solar panel 301 may be easily customized for the location. As will be appreciated by those skilled in the art, solar panels are aligned to catch the maximum amount of solar rays. The angle of solar panels differs by latitude to insure more exposure. Thus, differing latitudes will require different docking positions 360 to be utilized. The proposed invention eliminates the need for calculation of the optimum position. The docking positions 360 are preferably marked, possibly with alphanumeric characters. In this manner, instructions may be easily given to an installer to engage a certain docking position based upon the latitude. For instance, if a workman was engaged to install the device in Fayetteville, Ark., the workman would consult a guide map or chart, find his specific location, and then be provided with the docking position by its labeled character “B.”

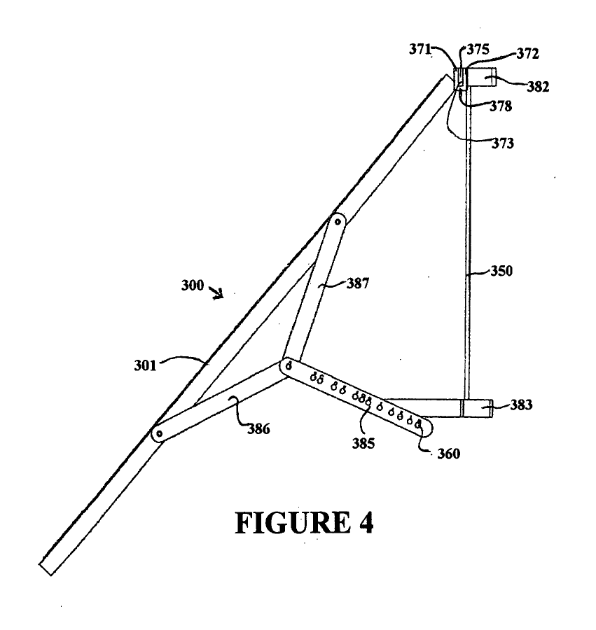

As shown in FIGS. 3-4, the top brace 382 has two engaging brackets 371, 372 and a securing base 378 to secure the solar panel. The engaging brackets 371, 372 form a gap 373 large enough to engage a brace 375 attached to the solar panel 301. The brace 375 is hinged to the solar panel, thereby providing a moving piece which can be motivated while angling the solar panel. The gap 373 formed between the brackets and the brace can engage the moving brace 375 during installation by tilting the solar panel and sliding the brace 375 into the gap 373. After the brace 375 has been engaged, the solar panel 301 can be secured by more permanent means. The housing and solar panel 301 can be mounted in three hours by one technician and a lift due to the panel brace 375 which allows the technician to put the panel 301 in place and let the brace 375 hold the weight while he connects the connecting arms to the attachment arms.

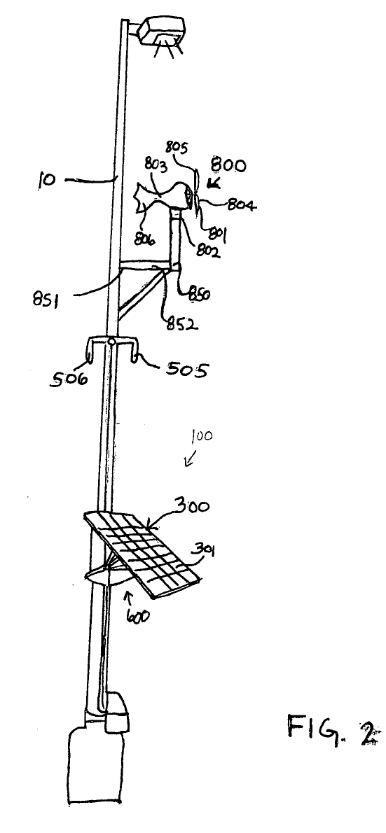

The wireless communication device 100 further includes at least one additional energy device 800, 900. As shown in FIG. 2, an additional energy device 800 may include a wind turbine 801 and a mount 850. The wind turbine 801, as shown in FIG. 13, includes a mounting dock 802, a cylindrical body 803, at least two blades 804, 805, and a rear fin 806 for balance. The mount 850 for the wind turbine 801 features at least a three foot set-off 852 from the mount 851 upon the cylindrical object 10.

The server 400 features an internet server 401 adapted to retrieve information and an information transmitter 402 adapted to transmit information from the internet server 401 to the access point 500. The server can retrieve data from any serial device through a serial cable connection between the device and the server. That data can be retrieved from any computer in the world. In another embodiment, the server 400 is incorporated with the solar controller 320 either as an internal server device or an embedded server. The server 400 further may be replaced with a server that is able to close sets of contacts which make possible: alarm and security systems, internet counter applications, lighting control applications, and scientific instrument applications.

The access point 500 features an access point system 501 (Cisco Systems, San Jose, Calif.) adapted to receive information from the server 400 and transmit an information signal to a wireless communication device via multiple antennas 505, 506. In a preferred embodiment, two 2.4 GH antennas (Cisco Systems, Inc., San Jose, Calif.) and one 5.8 GH antenna (Cisco Systems) mount above the housing 600. The antennas are mounted approximately thirty to forty feet above ground to insure a wide range for the information signal free of obstructions. Further, in a preferred embodiment, the access point system 501 and internet server 401 are housed together within the same casing.

The housing 600 includes a control station 601 having five sides and door 602 covering an opening 603. The housing 600 is constructed of metal and adapted to secure the server 400 and the access point 500 within an environmentally secure container. The housing 600 is adapted to be waterproof and temperature-controlled. The housing 600 includes vent panel 625 and a temperature regulating system 650 which protects the internal devices from overheating within the housing 600. The temperature regulating assembly 650 includes a thermostat 651 and a ventilation fan 653. The thermostat 651, upon reaching a predetermined temperature, closes a set of internal contacts which completes a circuit from the battery to the ventilation fan 653 to decrease the temperature within the housing assembly 600. As shown in the drawings, the device 100 may additionally include a second housing 675 which contains a reservoir battery 385. The second housing 675 has a separate mount 799 which is connected to the mount 700 of the primary housing 600.

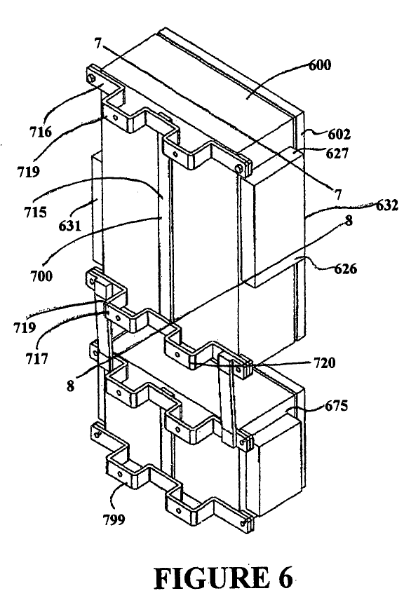

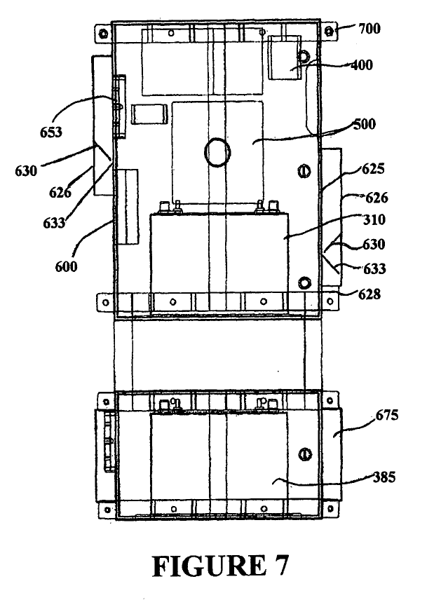

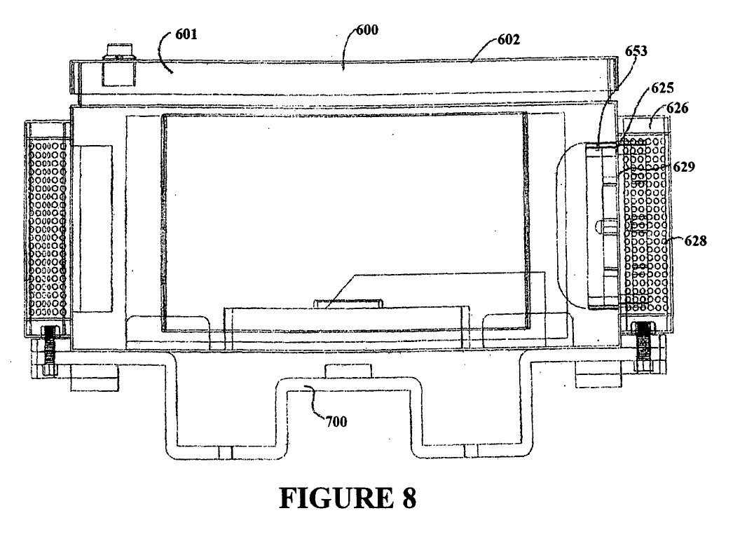

As shown in FIGS. 6-8, the vent panel 625 is covered by a five-sided housing 626 attached to the sides of the control station 601. The hot air from the control station 601 is released into the five-sided housing 626 via outlets 629 located on the side of the housing 600. The bottom 628 panels of the housing 626 include perforations allowing air to be released from the housing 626. Water or other condensation is blocked from entering the control station 601 by a series of angled slats 630, 633 running between the sides 631,632 of the housing 626 perpendicular to the vent panel 625. Preferably, two slats 630, 633 are used; a slat 633 connected to the housing 626 on the side 634 parallel to the vent panel 625 and a slat 630 connected to the housing 600 on the side having the vent panel 625. The slats 630, 633 are angled downward from the top 627 of the housing 626 at an obtuse angle. The angle of the slats 630, 633 is set to prevent water from flowing into the control station 601.

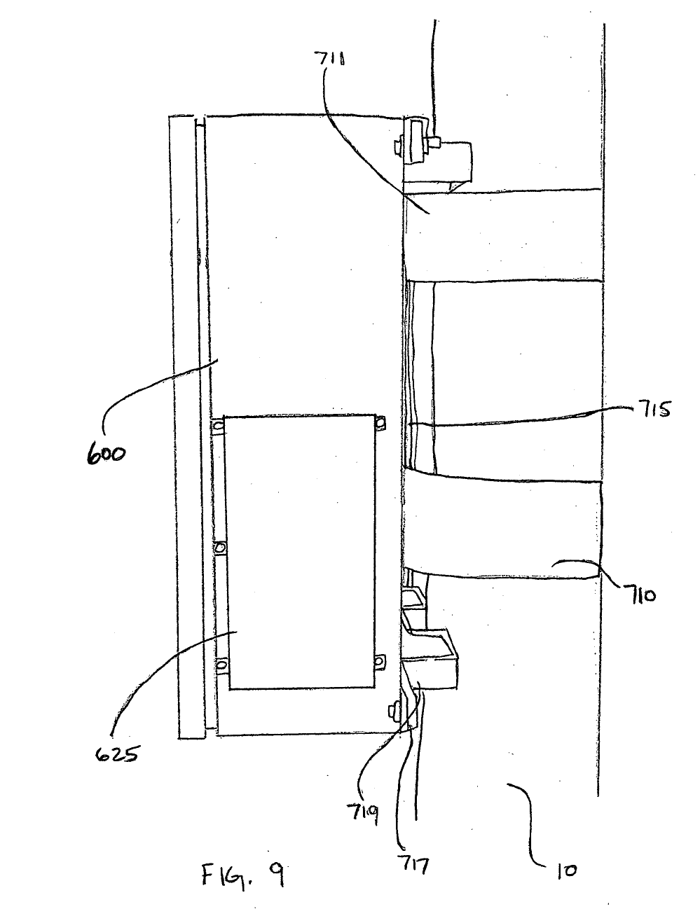

As shown in FIGS. 6-9, the mount 700 is adapted to secure the unitary housing 600 and energy source 300 to a stationary object having a circular surface. The mount 700 features the supporting brace 353 of the solar panel mount 350 and three braces: the top brace 362 of the solar panel mount 350, the mid brace 701, and the lower brace 702. In another embodiment, the mount 700 is separate from the mount 350 of the solar panel. The mount 700 in that embodiment features a supporting brace 715, a top brace 716, and a lower brace 717. The top brace 716 features a connecting anchor 359, 358 at each end of the brace. The top brace 716 and bottom brace 717 have rectangular protrusions 719, 720 on either side of the supporting brace 715 to space the mount away from the object 10 the mount is place upon. The supporting brace 715 further includes tension bands 710, 711 below the top brace 716 and above the lower brace 717. The tension bands 710, 711 are adapted to fit around and secure to the cylindrical object 10. The box can be mounted by one person because of the two mounting flanges on the top of the box which allows the technician to rest the weight of the box on the bracket while he inserts the bolts.

In certain areas, such as disaster-ravaged locations or remote locations, communication devices are limited in range or signal. The present invention provides a solution to this problem by supplying a communication access point 500. A network of devices may be set up by installing multiple devices around an area. Preferably, one device would be positioned at least one hundred feet from another device to insure coverage in an area. Each device provides communication coverage within a fifty foot radius.

It is further envisioned that this device 100 may be utilized in high traffic areas, such as retail outlets, airports or metropolitan roadways, to provide a communication device that utilizes a natural resource. Many retail outlets and cities now utilize cameras and other tracking devices to monitor individuals. The communication device 100 provides an energy source to various devices which then can be connected to an access point 400. In this manner, digital images can be transmitted to another location for remote viewing. In another application, the communication device 100 provides a merchant's server wirelessly connected by the access point 500 to receive data from RFID tags attached to products to monitor product locations within a selected area. In this manner, a merchant can easily determine quantities and movement of product to determine whether product is being stolen, whether product needs to be reordered, whether product is not selling, or the location of product for transport.

It is further envisioned that this device 100 may be utilized to provide VOIP, indoor and outdoor wireless connections, and remote WLAN WiFi equipment installations. The device 100 may be used to establish communication connections for rapid deployment installations, hot and cold temperature installations, handheld scanner applications, mesh networks, hot spot applications, and rapid deployment installations.

From the foregoing, it will be seen that this invention well adapted to obtain all the ends and objects herein set forth, together with other advantages which are inherent to the structure. It will also be understood that certain features and subcombinations are of utility and may be employed without reference to other features and subcombinations. This is contemplated by and is within the scope of the claims. Many possible embodiments may be made of the invention without departing from the scope thereof. Therefore, it is to be understood that all matter herein set forth or shown in the accompanying drawings is to be interpreted as illustrative and not in a limiting sense.

When interpreting the claims of this application, method claims may be recognized by the explicit use of the word ‘method’ in the preamble of the claims and the use of the ‘ing’ tense of the active word. Method claims should not be interpreted to have particular steps in a particular order unless the claim element specifically referring to a previous element, a previous action, or the result of a previous action.

What is claimed is:

1. A wireless communication device for the transfer of information, the device comprising:
an alternative energy source;
a server adapted to provide information;
an access point adapted to transmit a signal to one or more wireless communication devices, said access point comprising a wireless access point device;
a unitary housing, said housing adapted to enclose said server and said access point;
a mount adapted to secure said unitary housing to a stationary object.

2. The device of claim 1 further including a secondary energy source.

3. The device of claim 1, the alternative energy source including a solar panel.

4. The solar panel of claim 3 further including a mount adapted to align a solar panel for a latitudinal specific angle.

5. The device of claim 3, the alternative energy source further including a wind turbine.

6. The device of claim 1, the access point further comprising an antenna.

7. The housing of claim 1 further including a temperature regulating assembly.

8. A wireless communication device for the transfer of network information, the device comprising:
an alternative energy source;
a server adapted to provide information;
an access point which transmits a signal to a wireless communication device, said access point comprising a wireless access point device and an antenna;
a housing comprising a mounting frame and a casing adapted to enclose said server and said access point, said housing adapted to be secured to a stationary object.

9. The device of claim 8 further including a secondary energy source.

10. The device of claim 8, the alternative energy source including a solar panel.

11. The solar panel of claim 10 further including a mount adapted to align a solar panel for a latitudinal specific angle.

12. The device of claim 10, the alternative energy source further including a wind turbine.

13. The device of claim 8 further including a secondary antenna.

14. The housing of claim 8 further including a temperature regulating device.

15. A wireless communication device for the transfer of information, the device comprising:
at least one alternative energy source;
a server adapted to provide information;
an access point adapted to transmit a signal to a wireless communication device, said access point comprising a wireless access point device;
a unitary housing, said housing adapted to enclose said server and said access point;
a mount adapted to secure said unitary housing to a stationary object.

16. The device of claim 15 further including a secondary energy source.

17. The device of claim 15, said at least one alternative energy source comprising a solar panel.

18. The solar panel of claim 17 further including a mount adapted to align a solar panel for a latitudinal specific angle.

19. The device of claim 15, the access point further comprising an antenna.

20. The housing of claim 15 further including an internal temperature regulating device.
